(19) United States
(12) Patent Application Publication
(10) Pub. No.: US 2025/0069622 A1
(43) Pub. Date: Feb. 27, 2025

(54) Disk Drive Suspension Assembly With PZT Actuators Having Active And Inactive Regions

(71) Applicant: Magnecomp Corporation, Murrieta, CA (US)

(72) Inventors: Kuen Chee Ee, Chino, CA (US); Long Zhang, Winchester, CA (US); Treesoon Kotchaplayuk, Wangnoi (TH)

(21) Appl. No.: 18/802,302

(22) Filed: Aug. 13, 2024

Related U.S. Application Data
(60) Provisional application No. 63/534,281, filed on Aug. 23, 2023.

(51) Int. Cl. G11B 5/48

(52) U.S. Cl. CPC G11B 5/4833; G11B 5/483; G11B 5/4873

(57) ABSTRACT

A suspension assembly includes a load beam terminating in a hinge, a gimbal assembly mounted to the load beam, and a base plate connected to the hinge and including an opening. A PZT actuator is disposed in the opening and includes first and second opposing ends. The PZT actuator includes active and inactive regions both extending between the first and second opposing ends, PZT material disposed in both the active and inactive regions, and first and second electrodes configured to cause active expansion and contraction of the PZT material in the active region in response to voltage differentials applied to the first and second electrodes, and configured to not cause active expansion and contraction of the PZT material in the inactive region in response to voltage differentials applied to the first and second electrodes of the PZT actuator.

### CROSS-REFERENCE TO RELATED APPLICATIONS

This application claims the benefit of, and priority to, U.S. Provisional Application No. 63/534,281 filed on Aug. 23, 2023, which is hereby incorporated by reference in its entirety.

### FIELD OF THE INVENTION

The present disclosure relates generally to suspensions for supporting read/write heads over recording media. In particular, the present disclosure relates to a head suspension assembly having actuators mounted on the base plate.

### BACKGROUND OF THE INVENTION

Storage devices such as magnetic disk drive storage devices (“disk drives”) store data on, and read data from, a spinning disk medium using a read/write head positioned over the surface of the spinning disk medium. A suspension assembly is used to position the read/write head over concentric tracks of the spinning disk medium. As an example, as shown in FIG. 1, a suspension assembly 2 can include a load beam 4 with a gimbal assembly 6 (containing a read/write head) mounted near the distal end of the load beam 4 that allows the read/write head to fly closely over the surface of the spinning disk medium during operation. The proximal end of the load beam 4 terminates in a hinge 8 that is connected to a base plate 10. The base plate 10 is connected to an actuator arm 12, which is connected to an actuator motor (not shown) that rotates the actuator arm, thus moving the entire suspension assembly 2 relative to the spinning disk medium. During operation, the actuator motor is used to position the read/write head over a desired concentric track of the spinning disk to write data to, or read data from, the desired concentric track.

As disk drive manufactures continue to develop smaller yet higher storage capacity drives, the density of the concentric tracks on the disk increases, making them narrower and more closely spaced. As track density increases, however, it becomes increasingly difficult for the actuator motor to quickly and accurately position the read/write head over the desired concentric track. Therefore, it has become known to use a pair of piezoelectric (PZT) actuators 14 and 16 mounted in an opening of the base plate 10 as shown in FIG. 2. A conventional PZT actuator is made of a material that expands in all directions in a plane when a forward voltage differential is applied (i.e., apply a voltage to a first terminal of the actuator that is positive relative to a voltage or ground at a second terminal of the actuator), and contracts when a reverse voltage differential is applied (i.e., apply a voltage to the first terminal that is negative relative to a voltage or ground at a second terminal). Therefore, the pair of PZT actuators expands and contracts in response to opposite polarity drive voltage signals. For example, a forward voltage differential is applied to PZT actuator 14 causing it to expand, while a reverse voltage differential is applied to PZT actuator 16 causing it to contract, which together cause the distal portion of the base plate 10 to flex so that load beam 4 rotates in a clockwise direction (about the distal end of the base plate 10) to implement fine control of the read/write head position. To flex the base plate 10 to rotate the load beam 4 in a counterclockwise direction (about the distal end of the base plate 10), a reverse voltage differential is applied to PZT actuator 14 (causing it to contract) while a forward voltage differential is applied to PZT actuator 16 (causing it to expand). Thus, higher track positioning resolution can be achieved by complimenting the course positioning of the actuator motor with the fine positioning of the PZT actuators.

While the use of a pair of PZT actuators can provide better positioning resolution, it has been found that the driving of the pair of PZT actuators to rotate the load beam about an axis of rotation at the distal end of the base plate can excite an unwanted arm sway mode to occur, which are high frequency deflections that are induced in the actuator arm. For example, driving a pair of conventional PZT actuators having the configuration of FIG. 2 has been shown to excite an arm sway mode at approximately 10.3 kHz, which is shown in the graph of the actuator arm frequency response function in FIG. 3.

There is a need for a more stable suspension assembly design to control fine tune positioning of the read/write head without exciting unwanted arm sway modes.

### BRIEF SUMMARY OF THE INVENTION

The aforementioned problems and needs are addressed suspension assembly that includes a load beam including a proximal end terminating in a hinge, a gimbal assembly mounted to the load beam, a base plate including a distal end connected to the hinge and including a first opening, and a first PZT actuator disposed in the first opening and including first and second opposing ends that are mounted to first and second opposing ends of the first opening. The first PZT actuator includes an active region extending between the first and second opposing ends of the first PZT actuator, an inactive region extending between the first and second opposing ends of the first PZT actuator, PZT material disposed in the active region and the inactive region of the first PZT actuator, and a first electrode and a second electrode configured to cause active expansion and contraction of the PZT material in the active region of the first PZT actuator in response to voltage differentials applied to the first electrode and the second electrode of the first PZT actuator, and configured to not cause active expansion and contraction of the PZT material in the inactive region of the first PZT actuator in response to voltage differentials applied to the first electrode and the second electrode of the first PZT actuator.

Other objects and features of the present disclosure will become apparent by a review of the specification, claims and appended figures.

### BRIEF DESCRIPTION OF THE DRAWINGS

FIG. 1 is a perspective view of a conventional suspension assembly.

FIG. 2 is a top view of a conventional suspension assembly.

FIG. 3 is a graph showing actuator arm frequency response function for a conventional suspension assembly.

FIG. 4 is a top view of a suspension assembly according to a first example.

FIG. 5 is a top partial view of the suspension assembly according to the first example.

FIG. 6A is a top view of a PZT actuator.

FIG. 6B is a side cross sectional view of the PZT actuator of FIG. 6A.

FIG. 6C is another side cross sectional view of the PZT actuator of FIG. 6A.

FIG. 7A is a top view of the suspension assembly according to the first example, illustrating counterclockwise rotation of the load beam.

FIG. 7B is a top view of the suspension assembly according to the first example, illustrating clockwise rotation of the load beam.

FIG. 8 is a graph showing actuator arm frequency response function for both a conventional suspension assembly and the suspension assembly according to the first example.

FIG. 9A is a top view of a PZT actuator.

FIG. 9B is a side cross sectional view of the PZT actuator of FIG. 9A.

FIG. 9C is a side cross sectional view of the PZT actuator of FIG. 9A.

FIG. 10 is a top view of a suspension assembly according to a second example.

FIG. 11A is a top view of the suspension assembly according to the second example, illustrating counterclockwise rotation of the load beam.

FIG. 11B is a top view of the suspension assembly according to the second example, illustrating clockwise rotation of the load beam.

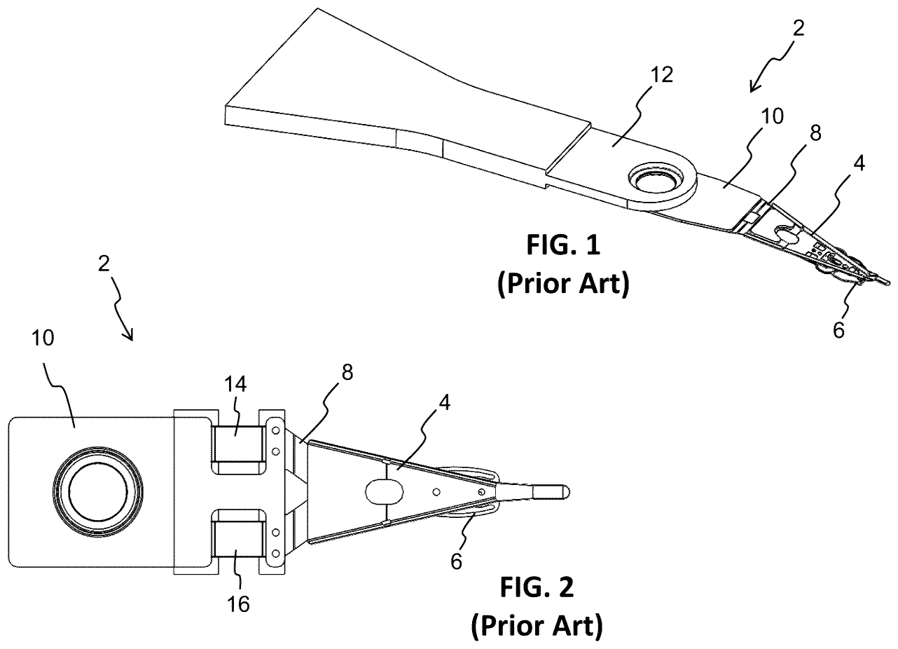

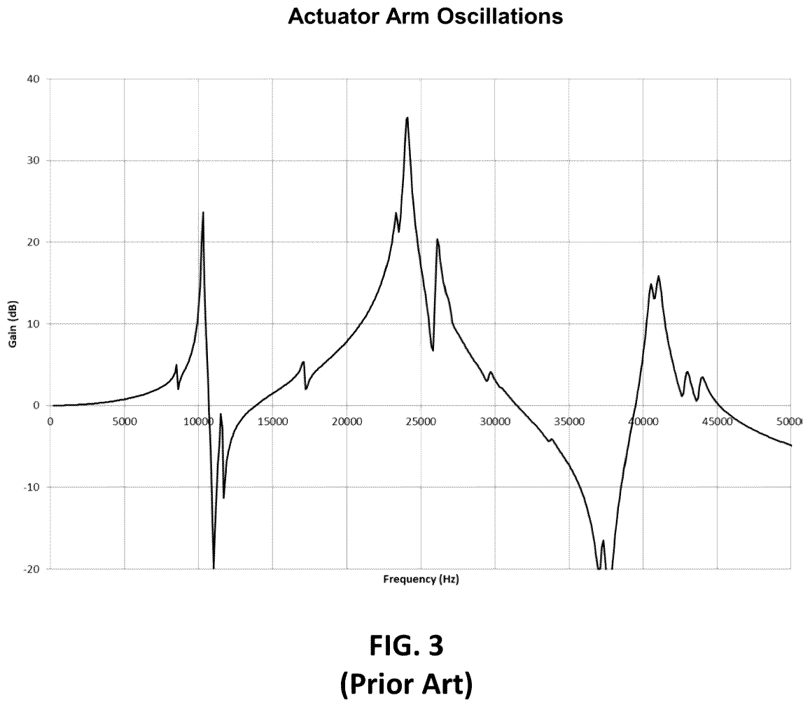

### DETAILED DESCRIPTION OF THE INVENTION

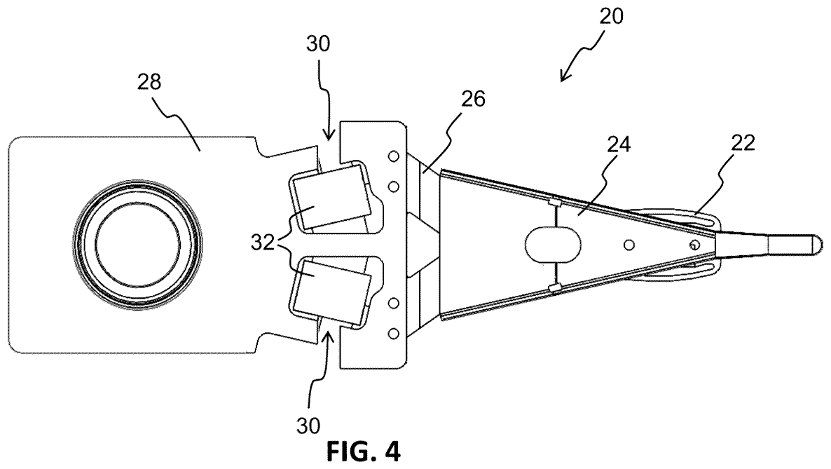

The present disclosure is directed to a disk drive suspension assembly with actuators with active and inactive regions to provide fine control of the read/write head positioning. The suspension assembly 20 is shown in FIG. 4. A gimbal assembly 22 (containing a read/write head) is mounted near a distal end of a load beam 24. The proximal end of the load beam 24 terminates in a hinge 26 that is connected to the distal end of a base plate 28. The proximal end of the base plate 28 is connected to an actuator arm (not shown), which in turn is connected to an actuator motor (not shown) which used to move the suspension assembly 20 to position the read/write head of the gimbal assembly 22 over the desired concentric track on the surface of a spinning disk (not shown).

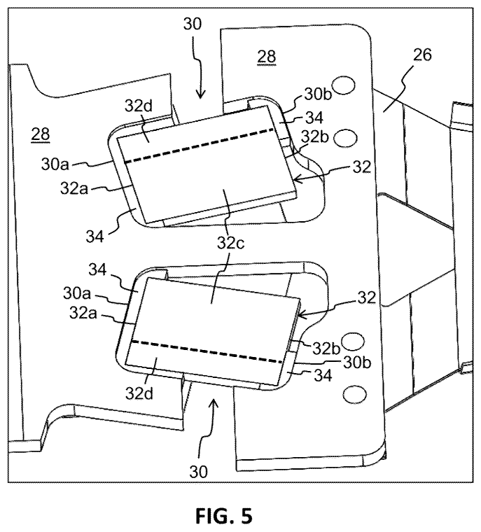

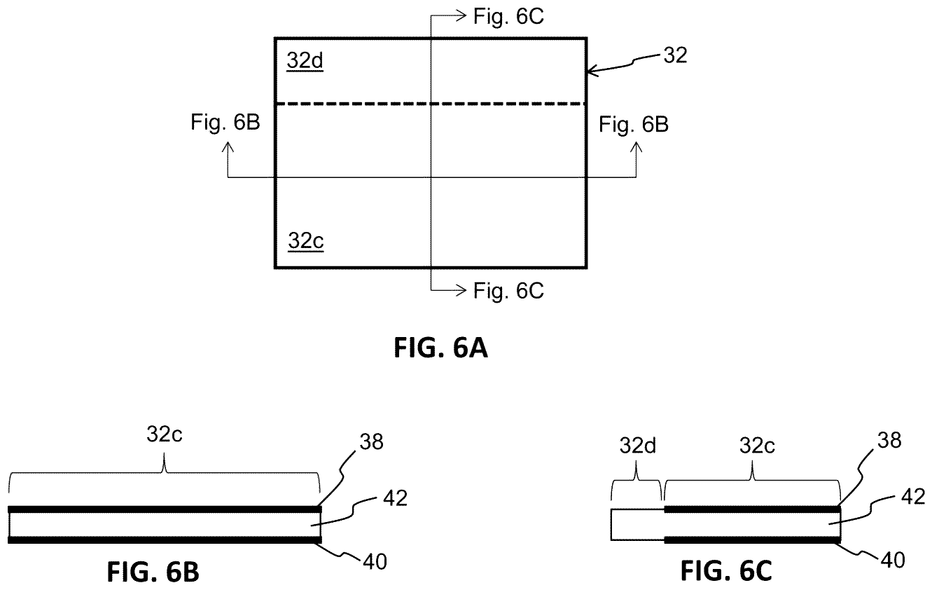

As shown in FIGS. 4-5, the distal end of the base plate 28 includes openings 30 in which PZT actuators 32 are mounted. Each PZT actuator 32 has opposing ends 32a and 32b mounted to opposing ends 30a and 30b of the respective opening 30 by, for example, and adhesive 34. Each PZT actuator 32 has an active region 32c and an inactive region 32d. As best shown in FIGS. 5, 6A, 6B and 6C, active region 32c is that portion of the PZT actuator 32 extending between opposing ends 32a and 32b that actively expands and contracts in response voltages applied to first and second electrodes 38/40 of the PZT actuator 32. Specifically, in active region 32c, a PZT material layer 42 is mostly or entirely disposed between first electrode 38 and second electrode 40, such that voltage differentials applied across first and second electrodes 38 and 40 cause the portion of PZT material layer 42 between the first and second electrodes 38 and 40 to expand and contract. Inactive region 32d is that portion of the PZT actuator 32 extending between opposing ends 32a and 32b in which the PZT material layer 42 is not disposed between first and second electrodes 38 and 40, and therefore does not actively expand and contract in response to voltage differentials applied across first and second electrodes 38 and 40. Inactive region 32d is by design a dead zone that does not actively expand and contract in response to the voltages applied to first and second electrodes 38 and 40. In one example, the active region 32c can be the portion of the PZT actuator 32 closest to a center of the base plate 28, and the inactive region 32d is the portion of the PZT actuator 32 furthest away from a center of the base plate 28. In one example, the inactive region 32d can be approximately 30% of the total area of the PZT actuator 32.

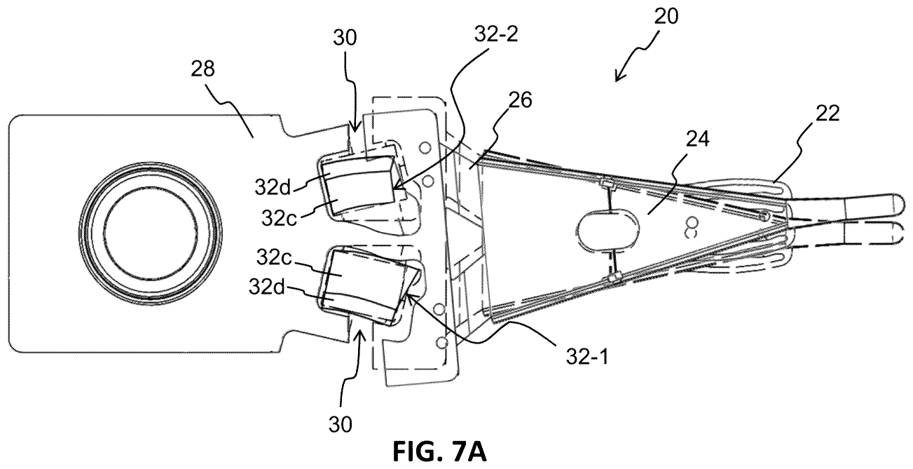

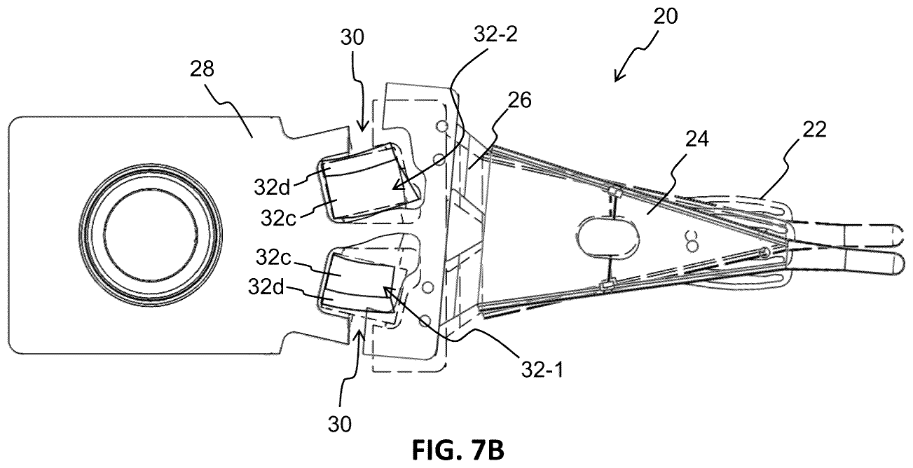

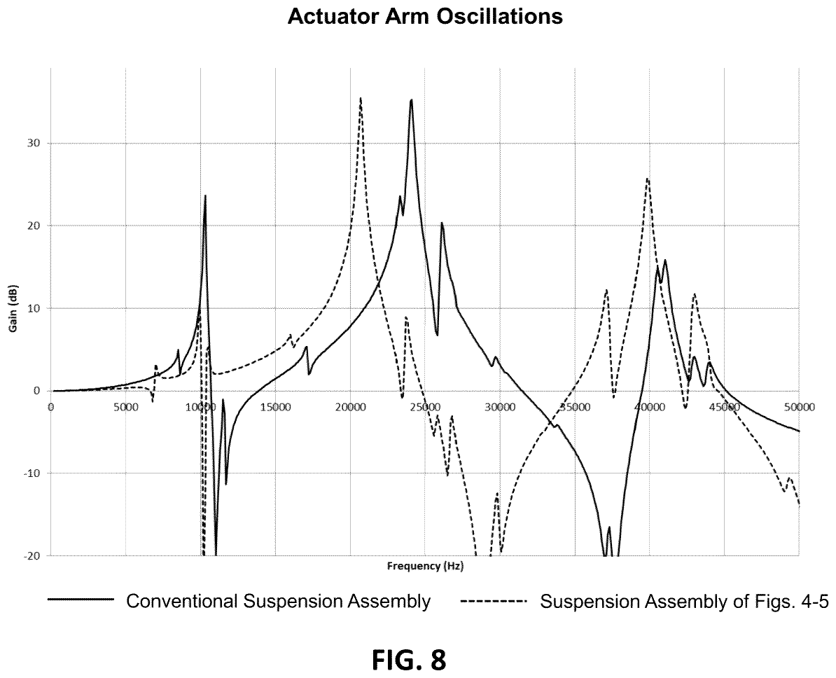

FIGS. 7A and 7B illustrate the expansion and contraction of the PZT actuators 32 to deflect the load beam 24 in a counter-clockwise direction. One of the PZT actuators can be referred to as first PZT actuator 32-1 disposed in one of the openings which can be referred to as first opening 30. The other of the PZT actuators can be referred to as second PZT actuator 32-2 disposed in other one of the openings which can be referred to as second opening 30. In operation, a voltage differential can be applied to the first and second electrodes 38, 40 of PZT actuator 32-1 to cause the active region 32c thereof to actively expand. The inactive region 32d of PZT actuator 32-1, which does not actively expand in response to any applied voltage differential, causes the active region 32c of PZT actuator 32-1 to bend generally in the same plane as the base plate 28 and towards the inactive region 32d of PZT actuator 32-1 as the active region 32c actively expands. Any expansion and bending of inactive region 32d of PZT actuator 32-1 is passively induced by the expansion and bending of the active region 32c of PZT actuator 32-1. At the same time, a voltage differential is applied to the first and second electrodes 38, 40 of PZT actuator 32-2 to cause the active region 32c thereof to contract. The inactive region 32d of PZT actuator 32-2, which does not actively contract in response to any applied voltage differential, causes the active region 32c of PZT actuator 32-2 to bend generally in the same plane as the base plate 28 and towards the inactive region 32d of PZT actuator 32-2 as the active region 32c actively contracts. Any contraction and bending of inactive region 32d of PZT actuator 32-2 is passively induced by the contraction and bending of the active region 32c of PZT actuator 32-2.

As shown in FIGS. 7A and 7B, the direction of the bending of both PZT actuators 32-1 and 32-2 is in the same direction, even though one actuator is expanding while the other is contracting. The amount of PZT actuator bending can be enhanced by attaching the entire proximal end 32a of each PZT actuator 32 to the corresponding proximal end 30a of the opening 30 with adhesive 34, while only attaching an outer portion of distal end 32b of the PZT actuator 32 to the corresponding distal end 30b of opening 30 with adhesive 34. The expanding and contracting PZT actuators 32-1 and 32-2 cause the distal portion of the base plate 10 to flex so that load beam 24 rotates in a counter-clockwise direction about a center of rotation located along the load beam 24 as shown FIG. 7A, or in a clockwise direction about a center of rotation along the load beam 24 as shown in FIG. 7B.

The bending of the PZT actuators 32-1 and 32-2 causes the center of rotation of the load beam 24 to be further away from the base plate 28 compared to if there was no bending, due to the lateral motion caused by the PZT actuator bending that accompanies the expansion and contraction of the PZT actuators 32-1 and 32-2. The displacement of the center of rotation away from the base plate 28 results in a reduction of the arm sway gain around 10 kHz, as shown in FIG. 8, which illustrates the actuator arm oscillations of the conventional suspension assembly design of FIG. 2 versus the suspension assembly design of FIGS. 4-5.

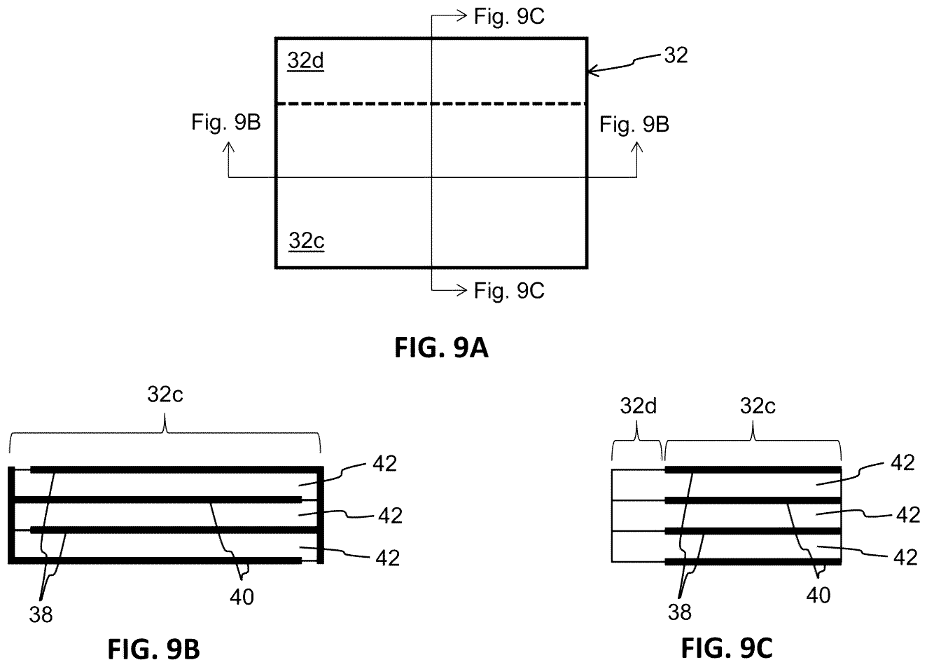

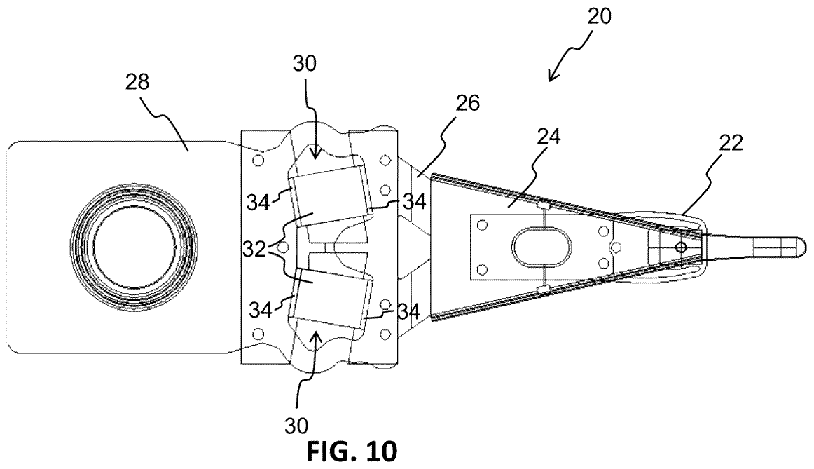

FIGS. 9A-9C illustrate another example, where PZT actuators 32 include multiple layers of PZT material 42. The illustrated example includes three layers (i.e., a middle layer under a top layer and over a bottom layer) of PZT material 42, but greater or fewer layers of PZT material 42 can be used. In the present example, first electrode 38 has a first portion disposed over the top layer of PZT material 42, and a second portion disposed between the middle and bottom layers of PZT material 42. The second electrode 40 has a first portion disposed between the top and middle layers of PZT material 42, and a second portion under the bottom layer of PZT material 42. In the active region 32c, each layer of PZT material 42 has a portion of one of the electrodes extending along its top surface and a portion of the other electrode extending along its bottom surface. In contrast, the inactive region 32d lacks the first and second electrodes 38 and 40 (i.e., no portions of the first and second electrodes 38/40 are disposed in the inactive region 32d).

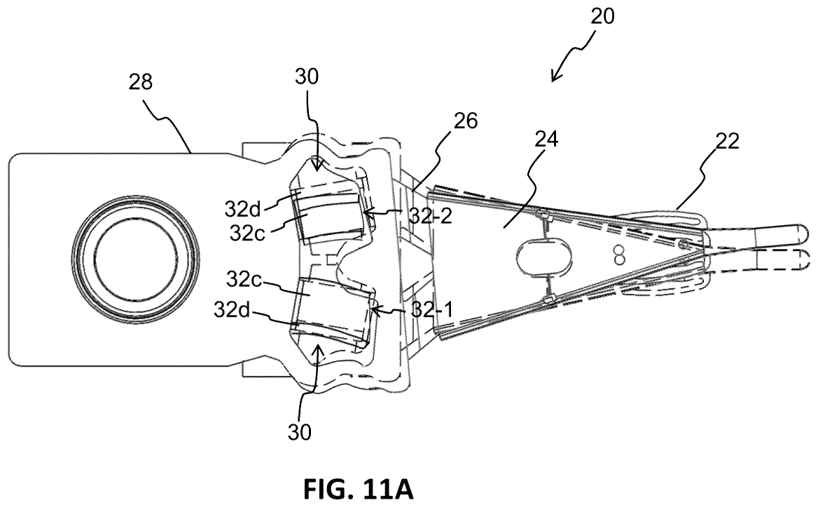

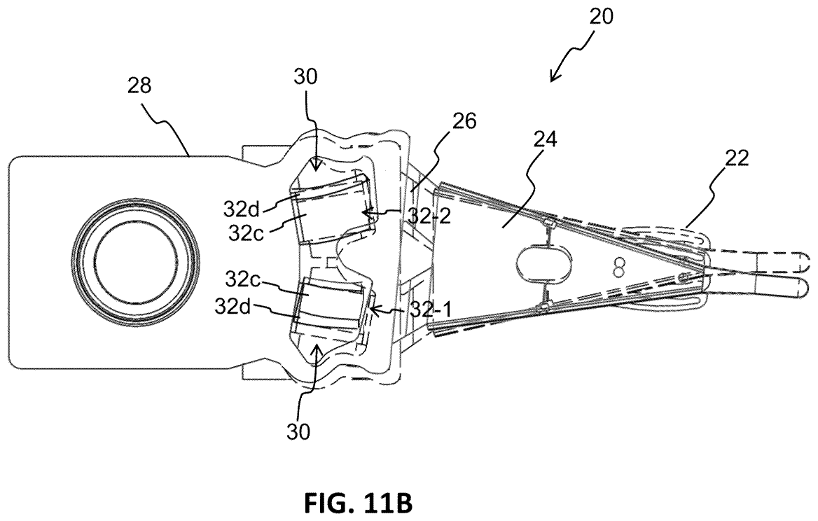

FIG. 10 illustrates another example of the suspension assembly 20, which is the same as the example of the suspension assembly 20 shown in FIG. 4, except that the openings 30 are fully enclosed by the base plate 28 (in comparison to the example shown in FIG. 4 where the openings 30 are not fully enclosed by the base plate 28). FIGS. 11A and 11B illustrate the expansion and contraction of the active regions 32c of the PZT actuators 32-1 and 32-2, respectively, to flex the distal portion of the load beam 24 to rotate the load beam 24 in a counter-clockwise direction as shown in FIG. 11A, or a clockwise direction as shown in FIG. 11B.

It is to be understood that the present disclosure is not limited to the example(s) described above and illustrated herein, but encompasses any and all variations falling within the scope of any claims. For example, for the PZT actuator of FIGS. 6A-6C, while the inactive region 32d lacks both first and second electrodes 38/40 so that no active expansion/contraction occurs to the PZT material 42 there between when voltage differentials are applied to the first and second electrodes 38/40, it may be possible for the inactive region 32d to include one of the first and second electrodes 38/40 so long as it lacks the other of the first and second electrodes 38/40, so that no active expansion/contraction occurs in the inactive region 32d when voltage differentials are applied to the first and second electrodes 38/40. References to the present disclosure or invention or examples herein are not intended to limit the scope of any claim or claim term, but instead merely make reference to one or more features that may be covered by one or more claims. Materials, processes and numerical examples described above are exemplary only, and should not be deemed to limit the claims.

What is claimed is:

1. A suspension assembly comprising:
a load beam including a proximal end terminating in a hinge;
a gimbal assembly mounted to the load beam;
a base plate including a distal end connected to the hinge and including a first opening; and
a first PZT actuator disposed in the first opening and including first and second opposing ends that are mounted to first and second opposing ends of the first opening, wherein the first PZT actuator comprises:
an active region extending between the first and second opposing ends of the first PZT actuator,
an inactive region extending between the first and second opposing ends of the first PZT actuator,
PZT material disposed in the active region and the inactive region of the first PZT actuator, and
a first electrode and a second electrode configured to cause active expansion and contraction of the PZT material in the active region of the first PZT actuator in response to voltage differentials applied to the first electrode and the second electrode of the first PZT actuator, and configured to not cause active expansion and contraction of the PZT material in the inactive region of the first PZT actuator in response to voltage differentials applied to the first electrode and the second electrode of the first PZT actuator.

2. The suspension assembly of claim 1, further comprising:
the distal end of the base plate including a second opening; and
a second PZT actuator disposed in the second opening and including first and second opposing ends that are mounted to first and second opposing ends of the second opening, wherein the second PZT actuator comprises:
an active region extending between the first and second opposing ends of the second PZT actuator,
an inactive region extending between the first and second opposing ends of the second PZT actuator,
PZT material disposed in the active region and the inactive region of the second PZT actuator, and
a first electrode and a second electrode configured to cause active expansion and contraction of the PZT material in the active region of the second PZT actuator in response to voltage differentials applied to the first electrode and the second electrode of the second PZT actuator, and configured to not cause active expansion and contraction of the PZT material in the inactive region of the second PZT actuator in response to voltage differentials applied to the first electrode and the second electrode of the second PZT actuator.

3. The suspension assembly of claim 2, wherein:
the inactive region of the first PZT actuator lacks the first electrode and the second electrode of the first PZT actuator; and
the inactive region of the second PZT actuator lacks the first electrode and the second electrode of the second PZT actuator.

4. The suspension assembly of claim 2, wherein:
the inactive region of the first PZT actuator lacks at least one of the first electrode and the second electrode of the first PZT actuator; and
the inactive region of the second PZT actuator lacks at least one of the first electrode and the second electrode of the second PZT actuator.

5. The suspension assembly of claim 2, wherein:
the first opening is fully enclosed by the base plate; and
the second opening is fully enclosed by the base plate.

6. The suspension assembly of claim 2, wherein:
the first opening is not fully enclosed by the base plate; and
the second opening is not fully enclosed by the base plate.

7. The suspension assembly of claim 2, wherein for each of the first and second PZT actuators:
the PZT material in the active region is disposed between the first electrode and the second electrode; and
the PZT material in the inactive region is not disposed between the first electrode and the second electrode.

8. The suspension assembly of claim 2, wherein each of the first and second PZT actuators comprises:
a middle layer of the PZT material;
a top layer of the PZT material disposed over the middle layer of PZT material;
a bottom layer of the PZT material disposed under the middle layer of PZT material;
wherein in the active region, the first electrode has a first portion disposed over the top layer of PZT material, and a second portion disposed between the middle layer of the PZT material and the bottom layer of the PZT material; and
wherein in the active region, the second electrode has a first portion disposed between the top layer of the PZT material and the middle layer of the PZT material and a second portion under the bottom layer of the PZT material.

9. The suspension assembly of claim 8, wherein for each of the first and second PZT actuators:
no portion of the first electrode is disposed in the inactive region; and
no portion of the second electrode is disposed in the inactive region.
